(19) United States
(12) Patent Application Publication
(10) Pub. No.: US 2012/0278231 A1
(43) Pub. Date: Nov. 1, 2012

(54) SYSTEM AND METHOD FOR HEDGING CURRENCY FLUCTUATIONS

(76) Inventor: Peter Novak, Carlsbad, CA (US)

(21) Appl. No.: 13/098,041

(22) Filed: Apr. 29, 2011

(51) Int. Cl. G06Q 40/00

(52) U.S. Cl. 705/41; 705/35

(57) ABSTRACT

An unspecified, variable bonus amount of phone card time (or some other product whose delivered value can be varied) is provided with a with a topup, where the topup amount has a fixed delivered amount in local currency and the topup is sold in other territories where foreign exchange rate fluctuations provide for a fluctuating cost of the fixed topup amount. The bonus amount may be applied to a bonus, such as a bonus phone card, that provides a hedge against exchange rate fluctuations by being a variable amount of bonus phone card time, for example, associated with the topup.

### BACKGROUND OF THE INVENTION

The present invention relates to topups and, more particularly, to topups having a fixed delivered amount in local currency and an unspecified, variable bonus amount.

To add funds to an account, such as a prepaid mobile phone account, a user may be directed to purchase a topup. Typically, a topup is purchased from a vendor for a specified amount of money. The topup is designed to add funds to the user's account. With a prepaid mobile phone account, the user may be instructed to dial a number on their prepaid phone and enter an access number and/or a personal identification number (PIN) that is given to the user when they purchase the topup.

Topup is often a cross-border cellphone recharge mechanism. At its core, providers must connect into the local mobile operator and send them the phone number and the amount to recharge. As this is a very simple mechanism, a topup can take various formats, such as a product sold online/mobile as an on demand product. Alternatively, the seller can create a PIN for the service and the PIN may be placed in physical distribution. Since the topup mechanism is so rudimentary, it can easily be tied to other products or services.

Since topups are often cross-border products, foreign exchange rate (fx) fluctuation is a key consideration in product pricing. Often, the cost of the topup may be in dollars (or another intermediate currency), while the delivered amount is in local currency. There are several hedging mechanisms currently in place, including (1) a variable local delivered amount and (2) a variable sales price.

In some countries, the local delivered amount is legally and technically allowed to be flexible. For example, one week, a mobile provider in a country may get 100 Pesos, which may cost 9 dollars, which may be sold for 10 dollars. The following week, however, the mobile provider may get something different, for example 99 Pesos, depending on fx. The cost will still be 9 dollars and the topup can continue to retail at 10 dollars. The main benefit here is stable sales conditions as the channel works with fixed margins.

For other destinations, local delivered amounts are fixed in local currencies. That means that the 100 Pesos is fixed and suppliers periodically adjust their selling price based on fx changes. One solution to the varying cost to provide a constant 100 Pesos is to vary the selling prices or related channel discounts. This works online and with other on-demand situations, where it is possible to adjust the selling price. However, when printed products are launched with long shelf lives, where neither the local delivered amount can be changed, nor the retail price can be adjusted, there are challenges in maintaining a stable cost for the sales channel.

As can be seen, there is a need for an apparatus and selling method for hedging currency exchange fluctuations where the retail price is kept constant while the profit margin is not affected by the foreign exchange rates.

### SUMMARY OF THE INVENTION

In one aspect of the present invention, a topup product comprises a topup value, fixed in a destination local currency of a destination provider; and a bonus value, variable in a purchasing local currency at a purchaser's location, the bonus value adapted to fluctuate depending at least in part upon foreign exchange rates between the destination local currency and the purchasing local currency.

In another aspect of the present invention, a method of hedging against foreign exchange rate fluctuations when selling a topup card comprises selling a consumer a topup having a value fixed in a destination local currency of a destination provider; and including a bonus value with the topup, the bonus value being variable in a purchasing local currency at a purchaser's location, the bonus value dependent upon foreign exchange rates between the destination local currency and the purchasing local currency.

In a further aspect of the present invention, a topup product comprises a topup value, fixed in a destination local currency of a destination provider; and a variable bonus value, the bonus value dependent upon foreign exchange rates between the destination local currency and the purchasing local currency, the bonus value is supplied as a variable number of minutes of phone card time.

These and other features, aspects and advantages of the present invention will become better understood with reference to the following description and claims.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides an unspecified, variable bonus amount of phone card time (or some other product whose delivered value can be varied) with a topup, where topup amounts have fixed delivered amounts in local currencies and the topup is sold in other territories where foreign exchange rate fluctuations provide for a fluctuating cost of the fixed topup amounts. The bonus, such as a bonus phone card, provides a hedge against exchange rate fluctuations by being a variable amount of bonus phone card time, for example, associated with the topup. Typically, the bonus value may be between about zero percent to about twenty percent of the value of the topup.

In some embodiments, the present invention includes a product with a specified retail denomination, containing at least dual, connected accounts, containing a preset currency amount (such as U.S. dollars) allocated to a topup and the remaining value allocated, for example, towards calling time via a phone card to that country. For example, the product may have a retail value of $10, which may provide $9 of topup to the destination mobile operator in local currency fixed amount. The remaining $1 may be a phone card account, having a variable delivery that the telecom operator can control. If the cost in U.S. dollars of the fixed local currency topup increases, the telecom operator can decrease the calling card minutes delivered. This variable mechanism, of course, allows the telecom operator to increase the delivered amount of the bonus (phone card time, for example), if the fx is in the favor of the telecom operator. Typically, the bonus will be a phone card since phone cards and topups are a natural combination, as senders of remittance or other cross border products/services often call the destination after sending the topup. In some embodiments, the bonus may be controlled by the telecom operator or may be controlled by the producer/seller of the topup product, whether the producer is a telecom or not.

In some embodiments of the present invention, to use the topup, a customer may first purchase a physical topup product in a store. The consumer may then access the topup platform, typically via an interactive voice response (IVR) system and by entering a PIN supplied with the product. The consumer then may define a destination number to top up. If the number is correct and the transaction completes, the customer can access the bonus, such as a phone card, via a separate access number and PIN and make a call on the telecom operator's network for the length of time the bonus offers, at that time, to that destination or another destination of the purchaser's choosing. In some embodiments, the topup PIN may be the same at the phone card PIN. In other embodiments, different PINs for the topup and phone card may be supplied. The topup platform may include software on a host computer, the software adapted to receive the PIN from the customer, verify the PIN and send the appropriate funds to the destination number.

The product, according to embodiments of the present invention, hedges against foreign currency exchange rate fluctuations and allows a telecom operator to advertise a continued fixed amount of delivered topup in local currency, parallel to a fixed cost structure in the selling country. A fixed sales cost structure allows the telecom operator to fix denominations, discounts, and the like, in the selling currency.

The product may be a virtual product sold, for example, over the internet. In other embodiments, the product may be a paper, plastic, or some other physical material product for retail sale.

It should be understood, of course, that the foregoing relates to exemplary embodiments of the invention and that modifications may be made without departing from the spirit and scope of the invention as set forth in the following claims.

What is claimed is:

1. A topup product comprising:
a topup value, fixed in a destination local currency of a destination provider; and
a bonus value, variable in a purchasing local currency at a purchaser's location, the bonus value adapted to fluctuate depending at least in part upon foreign exchange rates between the destination local currency and the purchasing local currency.

2. The topup product of claim 1, wherein the bonus value is supplied as a variable number of minutes of phone card time.

3. The topup product of claim 1, wherein the topup product is a printed retail product with a personal identification number included in the topup product.

4. The topup product of claim 2, wherein the topup product includes a personal identification number for placing a call with the phone card time.

5. The topup product of claim 1, wherein the topup product is supplied as a virtual topup product.

6. The topup product of claim 1, wherein the purchasing local currency is U.S. dollars.

7. The topup product of claim 1, wherein the bonus value is between zero percent and about twenty percent of the topup value.

8. A method of hedging against foreign exchange rate fluctuations when selling a product, the method comprising:
selling to a consumer the product having a value fixed in a destination local currency of a destination provider; and
including a bonus value with the product, the bonus value being variable in a purchasing local currency at a purchaser's location, the bonus value dependent upon foreign exchange rates between the destination local currency and the purchasing local currency.

9. The method of claim 8, wherein the product is a topup card.

10. The method of claim 9, wherein the bonus value is supplied as a phone card having a variable number of calling minutes depending on the bonus value.

11. The method of claim 8, wherein the purchasing local currency is U.S. dollars.

12. The method of claim 10, wherein the topup is provided by a telecom operator and the phone card is usable on a network of the telecom operator.

13. A topup product comprising:
a topup value, fixed in a destination local currency of a destination provider; and
a variable bonus value, the bonus value adapted to fluctuate depending at least in part upon foreign exchange rates between the destination local currency and the purchasing local currency, the bonus value is supplied as a variable number of minutes of phone card time.

14. The topup product of claim 13, wherein the topup product is a printed retail product with a personal identification number included in the topup product.

15. The topup product of claim 13, wherein a purchasing local current is U.S. dollars.

16. The topup product of claim 13, wherein the bonus value is between zero percent and about twenty percent of the topup value.
